(19) United States
(12) Patent Application Publication
(10) Pub. No.: US 2024/0276419 A1
(43) Pub. Date: Aug. 15, 2024

(54) MAP INFORMATION SIGNALING FOR POSITIONING AND RADIO FREQUENCY SENSING

(71) Applicant: QUALCOMM Incorporated, San Diego, CA (US)

(72) Inventors: Marwen ZORGUI, San Diego, CA (US); Rajat PRAKASH, San Diego, CA (US); Srinivas YERRAMALLI, San Diego, CA (US)

(21) Appl. No.: 18/169,770

(22) Filed: Feb. 15, 2023

(51) Int. Cl. H04W 64/00; G01S 7/00; G01S 13/00

(52) U.S. Cl. CPC H04W 64/00; G01S 7/006; G01S 13/003

(57) ABSTRACT

In an aspect, a UE may transmit, for a network node, a request for map information for at least one of a positioning session or an RF sensing session. The UE may receive, from the network node, a response including the map information. The UE may perform a set of measurements for at least one of the positioning session or the RF sensing session based on the map information. In another aspect, a first network node may receive at least one of a set of positioning measurements or a set of sensing measurements. The first network node may receive map information from a second network node. The first network node may calculate at least one of a first positioning state of a target entity or a first sensing state based on the map information and at least one of the set of positioning measurements or the set of sensing measurements.

### TECHNICAL FIELD

The present disclosure relates generally to positioning systems, and more particularly, to positioning systems involving map information.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment are provided. The apparatus may include memory and at least one processor coupled to the memory. The at least one processor, based at least in part on information stored in the memory may be configured to transmit, for a network node, a request message for map information for at least one of a positioning session or a radio frequency (RF) sensing session. The at least one processor may also be configured to receive, from the network node, a response including the map information. The at least one processor may be further configured to perform a first set of measurements for at least one of the positioning session or the RF sensing session based on the map information.

In another aspect of the disclosure, a method, a computer-readable medium, and an apparatus at a first network node are provided. The apparatus may include memory and at least one processor coupled to the memory. The at least one processor, based at least in part on information stored in the memory may be configured to receive at least one of a set of positioning measurements or a set of sensing measurements. The at least one processor may also be configured to receive map information from a second network node. The at least one processor may be further configured to calculate at least one of a first positioning state of a target entity or a first sensing state based on the map information and at least one of the set of positioning measurements or the set of sensing measurements.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 depicts a call flow diagram illustrating a method of wireless communication in accordance with various aspects of this present disclosure.

FIG. 6A depicts a call flow diagram illustrating a method of wireless communication in accordance with various aspects of this present disclosure.

FIG. 6B depicts a call flow diagram illustrating a method of wireless communication in accordance with various aspects of this present disclosure.

FIG. 7 depicts a call flow diagram illustrating a method of wireless communication in accordance with various aspects of this present disclosure.

FIG. 8 depicts a call flow diagram illustrating a method of wireless communication in accordance with various aspects of this present disclosure.

FIG. 9 is a flowchart illustrating a method of wireless communication at a wireless entity in accordance with various aspects of this present disclosure.

FIG. 10 is a flowchart illustrating a method of wireless communication at a network entity in accordance with various aspects of this present disclosure.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

Various aspects relate generally to positioning systems. Some aspects more specifically relate to positioning or RF sensing utilizing map information. In some examples, a UE may request and receive map information regarding an environment in which a target entity for which a positioning or RF sensing session is to be performed. The UE may request and receive the map information from a coordinator node (e.g., a location management function (LMF), a sensing management function (SnMF), or a base station), an external network entity (e.g., a geographic information system (GIS)-based database), or another UE that includes the map information. Based on the map information, the UE may perform a set of measurements for the positioning or RF sensing session. The UE may provide the set of measurements to the coordinator node, which may calculate a positioning or RF sensing state of the target entity. Alternatively, the UE may calculate the positioning or RF sensing state of the target entity based on the set of measurements.

Particular aspects of the subject matter described in this disclosure can be implemented to realize one or more of the following potential advantages. By utilizing map information associated with the particular environment in which the target entity is located, obstacles in the environment in which the target entity is included may be considered, and therefore, the positioning or sensing state (e.g., the direction, heading, or velocity) of the target entity may be more accurately determined.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

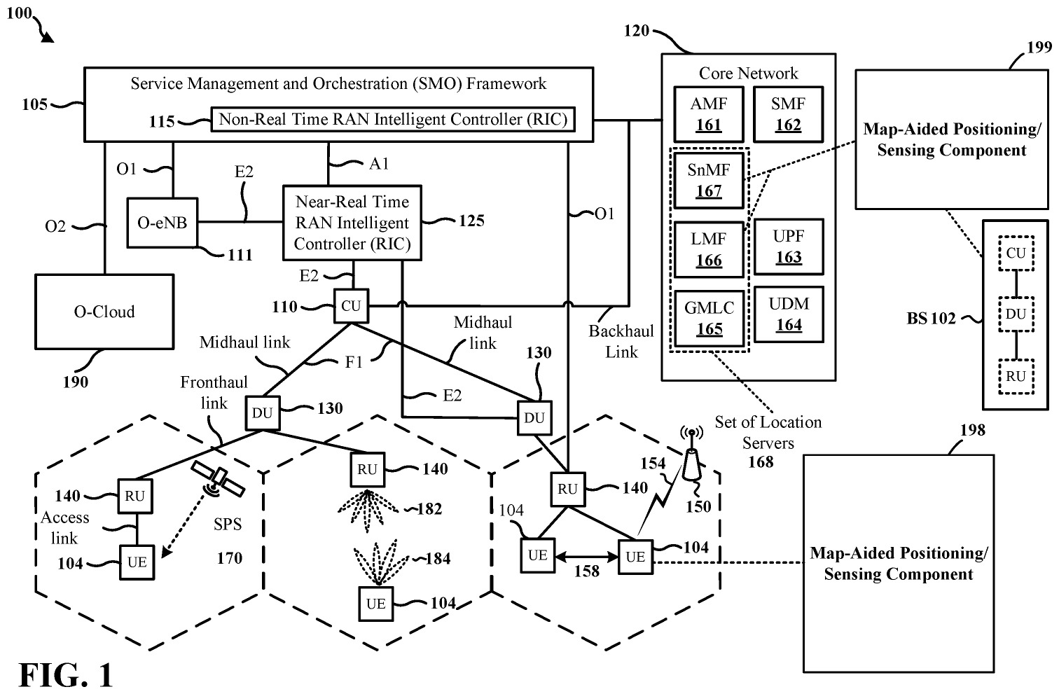

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166, and a Sensing Management Function (SnMF) 167. However, generally, the one or more location servers 168 may include one or more location/positioning servers, which may include one or more of the GMLC 165, the LMF 166, the SnMF 167, a position determination entity (PDE), a serving mobile location center (SMLC), a mobile positioning center (MPC), or the like. The GMLC 165, the LMF 166, and the SnMF 167 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The SnMF 167 manages and/or coordinates RF sensing sessions for a target entity, for example, by determining and/or configuring nodes (e.g., TRPs or UEs) for the RF sensing sessions. The SnMF 167 may also receive measurements and/or additional information from a node and determine a sensing result (e.g., a position of the target entity) based on the measurements and/or additional information. The SnMF 167 may be a standalone entity of the core network 120, may be part of an already existing entity (e.g., such as the LMF 166), or may be located at the base station 102. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a map-aided positioning/sensing component 198 that may be configured to transmit, for a network node, a request message for map information for at least one of a positioning session or an RF sensing session, to receive, from the network node, a response including the map information, and to perform a first set of measurements for at least one of the positioning session or the RF sensing session based on the map information. In certain aspects, the base station 102 may have a map-aided positioning/sensing component 199 that may be configured to receive at least one of a set of positioning measurements or a set of sensing measurements, to receive map information from a second network node, and to calculate at least one of a first positioning state of a target entity or a first sensing state based on the map information and at least one of the set of positioning measurements or the set of sensing measurements.

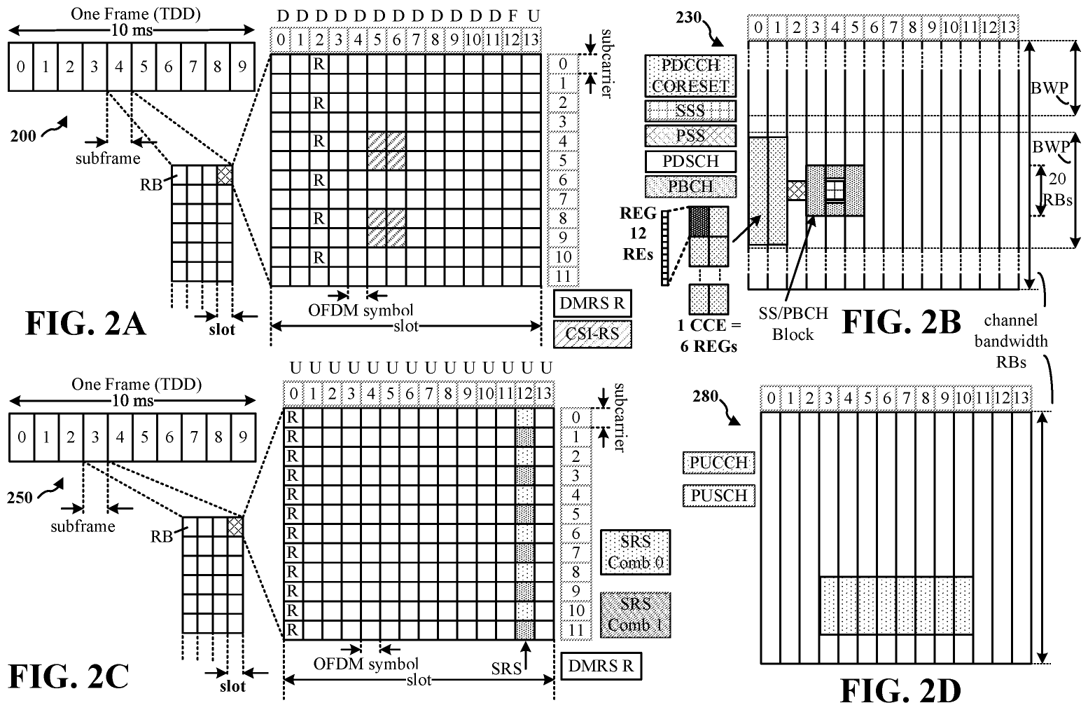

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

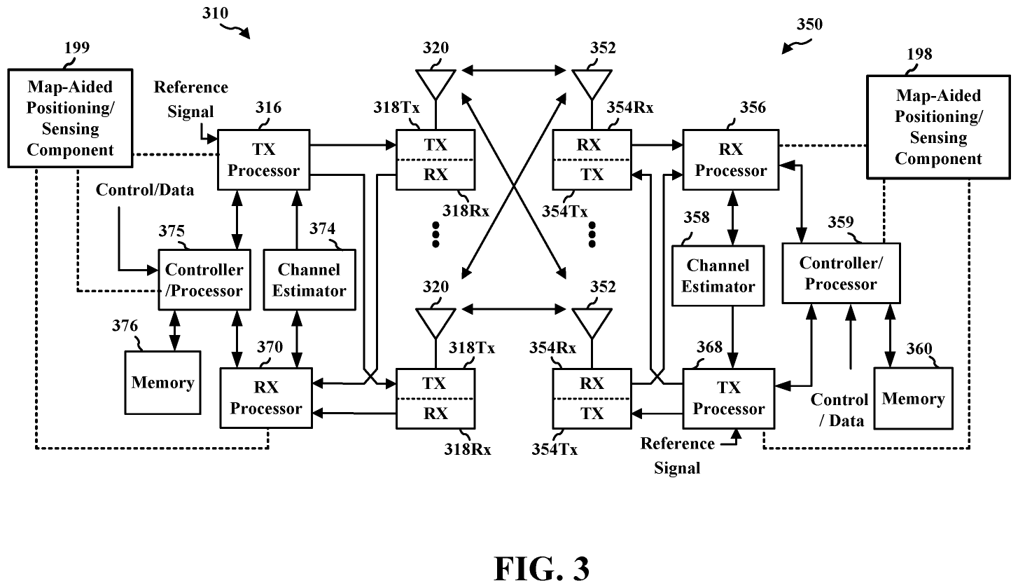

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the map-aided positioning/sensing component 198 of FIG. 1.

At least one of the TX processor 316, the RX processor 370, and the controller/processor 375 may be configured to perform aspects in connection with the map-aided positioning/sensing component 199 of FIG. 1.

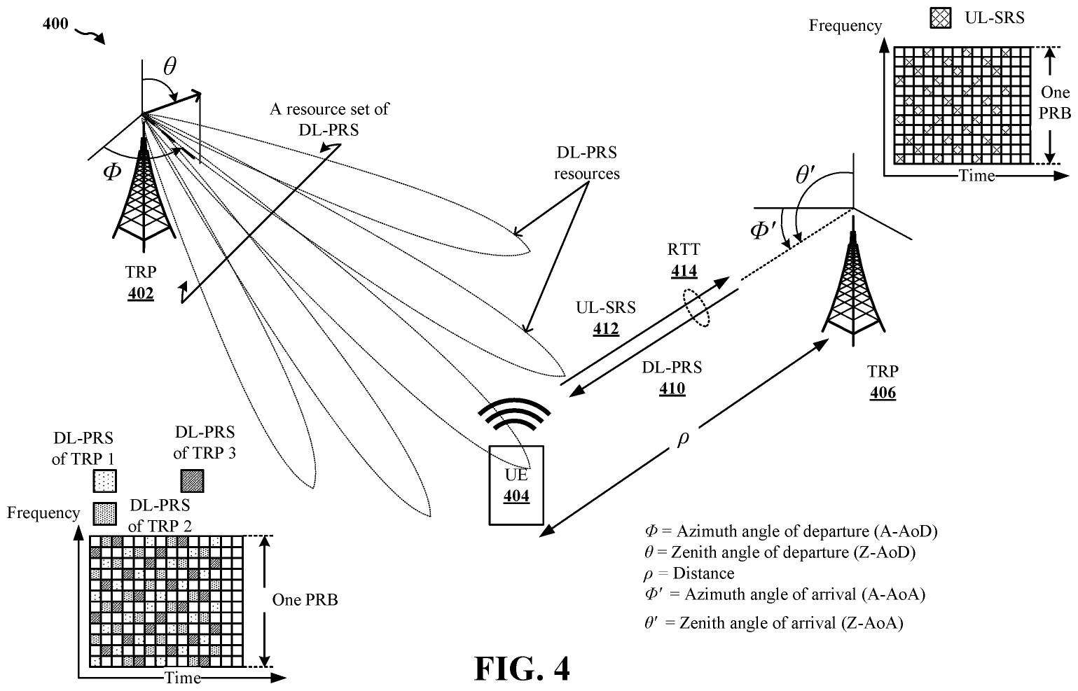

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an access point (AP), etc.) may also be configured to include sensing capabilities, where the wireless device may be able to sense (e.g., detect and/or track) one or more objects or target entities of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device” or a “sensing node.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. An RF sensing session may be referred to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc.

For positioning sessions, the fusion of map information and radio signal measurements may enhance the positioning performance. For example, map-aided positioning may be utilized for satellite selection. Based on the future (or predicted) three-dimensional (3D) environment of a vehicle and the known satellite locations, one or more satellites that will be visible during the predicted vehicle trajectory may be determined and selected. In another example, map-aided positioning may be utilized for adaptive sampling of inertial sensors, where sensors of a device may be turned on (e.g., activated) in areas where positioning is challenging (as indicated by the map) to improve the positioning accuracy and the sensors are turned off (e.g., deactivated) in areas which are less challenging for positioning. In a further example, map-aided positioning may be implemented using non-line-of-sight (NLOS) paths, where NLOS components are measured and projected on the map to provide additional equations for positioning. In yet a further example, map-aided positioning may be utilized for crowdsourcing for radar localization, where global reference maps may be generated based on radar inputs from different vehicles, which are then used to match to a new car radar signature input to generate the new car location.

Like positioning, RF sensing processing may be improved by leveraging knowledge from the geographical environment where sensing occurs. Utilizing map information may be useful for various scenarios. For example, map information may be utilized to locate targets. Having access to map information, the sensing entity may estimate the potential paths corresponding to a given observed delay. This may be useful information that can be leveraged for accurate target detection. In another example, map information can be used to predict future motion of detected targets. For instance, a detected moving target in a road is likely to continue its movement along a specific trajectory (e.g., a specific lane for a car, a sidewalk for a passenger, etc.). Estimating the target behavior may help improve tracking and sensing performance (e.g., by determining more appropriate beam coverage/sweeping). In a further example, map information may help inform the decision of which targets to track in the case of multi-target objects. For example, at a road intersection, the sensing entity goal may be to track vulnerable road users (VRUs), such as humans walking close to the highway, rather than other detected objects in the environments.

In accordance with various aspects of the present disclosure, the enablement of the usage of map information in positioning and cellular RF sensing and procedures and the signaling of messages enabling the usage of map information for positioning and cellular RF sensing are described herein. For example, to obtain the map information, a coordinator node (e.g., the LMF 166, the SnMF 167, or the base station 102) may send a map request message to another core network entity or an entity external to the core network 120 (e.g., a 3GPP core network) that stores map information (or data). The map request message may be configured to request the map information from the external entity. The coordinator node may receive a corresponding response in a map response message. The response message may be configured to include the requested map information. The map information may include a dataset that contains absolute locations (e.g., the latitude and longitude) of environmental constraints or features. The features may include both natural features and man-made features. Examples of natural features include, but are not limited to, trees, vegetation, canyons, mountains, etc. Examples of man-made features include, but are not limited to, roads, buildings, houses, bridges, poles, etc.

The external map entity (e.g., the non-3GPP entity) that stores the map information may be a trusted entity that can communicate with the coordinator node, for example, through other network entities (e.g., 3GPP network entities). An example of the external map entity includes, but is not limited to geographic information system (GIS)-based database, which may enable exchange of geographic data (e.g., map information) using a standardized format.

The map request provided to the external map entity may include a geographical boundary of the requested map. The map request may also include a constraint on the map generation time (e.g., the map requested was to generated/updated within the last X units of time (e.g., minutes, hours, days, etc.)). The map request may further indicate a format of the map (e.g., the external map entity may support various formats, and the coordinator node may support just a subset of the formats). The map request may additionally indicate the dimensionality of the map (e.g., a two-dimensional (2D) map, or a three-dimensional (3D) map), etc.

The map response received from the external map entity may include the requested map within the geographical boundaries specified in the map request. The map request may also include an indication of the map format. The map response may indicate the non-availability of the requested map in the event the map satisfying the request is not available. The map response may also include the reason for the unavailability (if available).

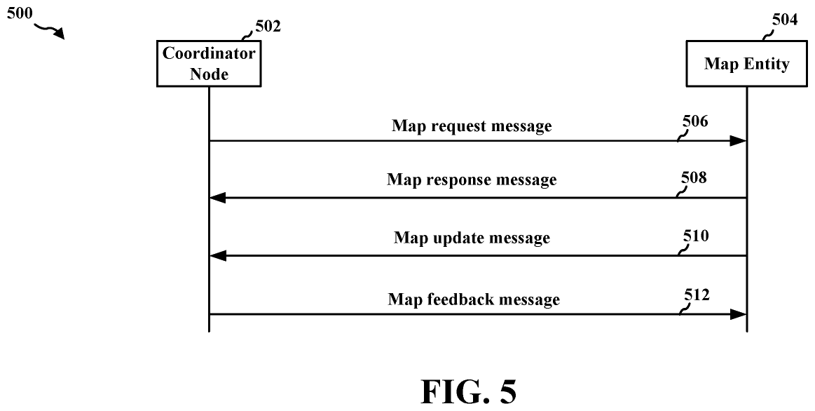

FIG. 5 depicts a call flow diagram 500 illustrating a method of wireless communication in accordance with various aspects of this present disclosure. As shown in FIG. 5, the call flow diagram 500 includes a coordinator node 502 and a map entity 504. Examples of the coordinator node 502 include the LMF 166, the SnMF 167, or a network node, such as the base station 102, or the base station 310. Examples of the map entity 504 include, but are not limited to, a GIS-based database. Although aspects are described for the network node, the aspects may be performed by a network node in aggregation and/or by one or more components of the network node (e.g., such as a CU 110, a DU 130, and/or an RU 140). As shown in FIG. 5, at 506, the coordinator node 502, at 506, may provide a map request message for map information, for example, for a positioning session or an RF sensing session. In some aspects, the map request message may indicate a geographical boundary associated with the requested map information, a constraint specifying a time frame for when the map information was generated, a format of the map information, and/or a dimensionality of the map information.

At 508, the coordinator node 502 may receive a response message including the map information from the map entity 504. In some aspects, the response message may include an indication of the format of the map information. The map information may be based on the geographical boundary indicated in the request message provided at 506. In the event that the requested map is unavailable, the map response message may indicate the non-availability of the requested map. The map response message may also include the reason for the unavailability (if available).

In some aspects, the external map entity may update its response message to the coordinator node if the corresponding map information has been updated. The update may be signaled through a map update message. The map update message may be configured to include additional, supplemental, or updated (or newer) map information (than compared to the map information provided via the map response message). For example, referring to FIG. 5, at 510, the map entity 504 may provide a map update message to the coordinator node 502. The map update message may include updated map information for the positioning or the RF sensing session.

In some aspects, the coordinator node may provide some feedback for the received map information to the external map entity. The map feedback message provided by the coordinator node may be configured to include information indicative of map invalidity. For instance, the coordinator node may execute map validity tests and may determine (e.g., or suspect) that parts of the map information are not valid. The coordinator node may signal this observation to the external map entity, including potential reasons for invalidity. The map feedback message may also include map feedback information. For example, the coordinator node may infer, based on its processing, the existence of geographical elements in the environment that are not represented by the map information (e.g., the map information may not be up-to-date, and the coordinator node, using SLAM (simultaneous localization and mapping) techniques, may be able to scan the environment and detect objects in it). The coordinator node may indicate the objects in the map to the external map entity utilizing a standardized format. This can be seen as a type of feedback or assistance information to the external map entity. For example, referring to FIG. 5, at 512, the coordinator node 502 may provide a map feedback message to the map entity 504. The map feedback message may include updated map information for the positioning or the RF sensing session. The map feedback message may include an indication that at least a portion of the map information is invalid or incomplete.

In some aspects, the coordinator node may request map information for each positioning or RF sensing session on-demand (i.e., whenever the map information is needed). The coordinator node may also store map information for a particular time window to help serve other UEs that may request the map information from the coordinator node. For network-based positioning or RF sensing, the coordinator node may process the map information itself when generating the positioning or sensing result (or state). For UE-based positioning or RF sensing, the coordinator node or the external map entity may share map information with the UE. A positioning state may indicate at least one of a location of the target entity, a velocity of the target entity, a heading of the target entity. A sensing result may indicate at least one of a change of an environment in which the target entity is included, at least one physiological characteristic of a target entity (e.g., a heart rate, a respiration rate, body temperature, etc.), a location of the target entity, a velocity of the target entity, a heading of the target entity, etc.

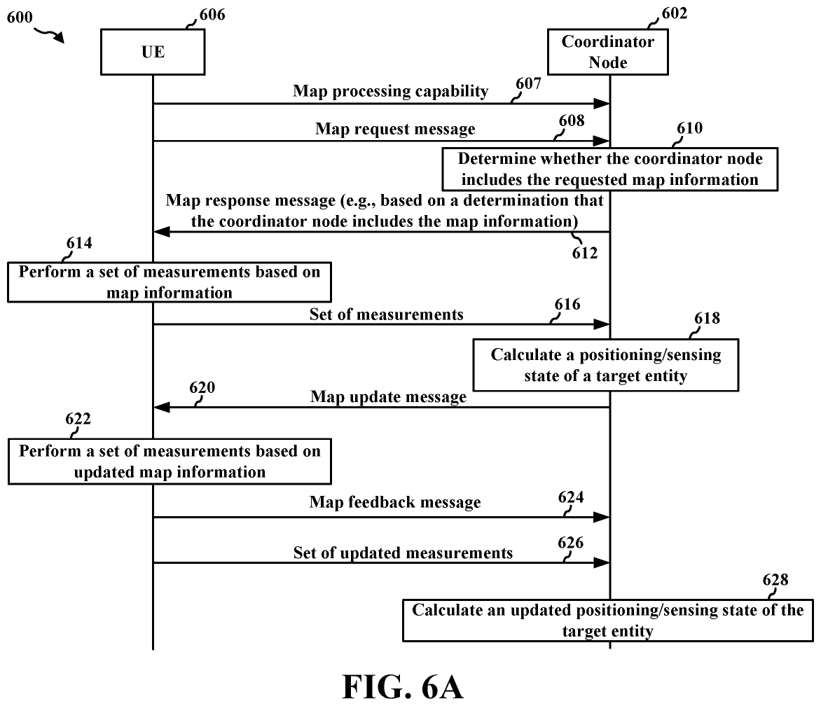

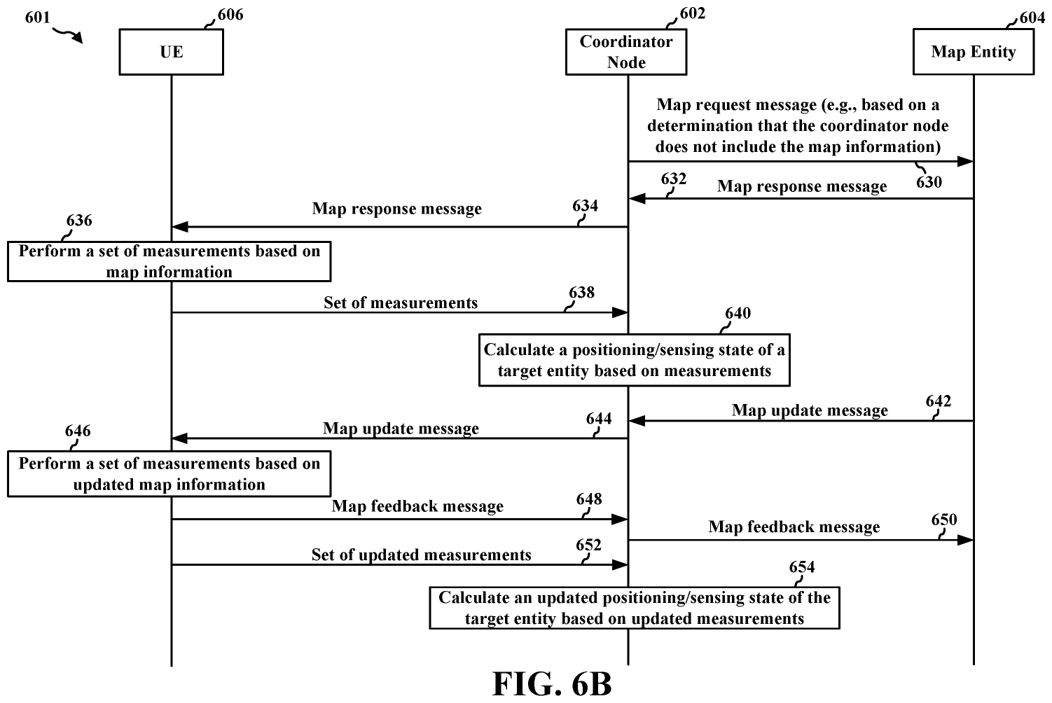

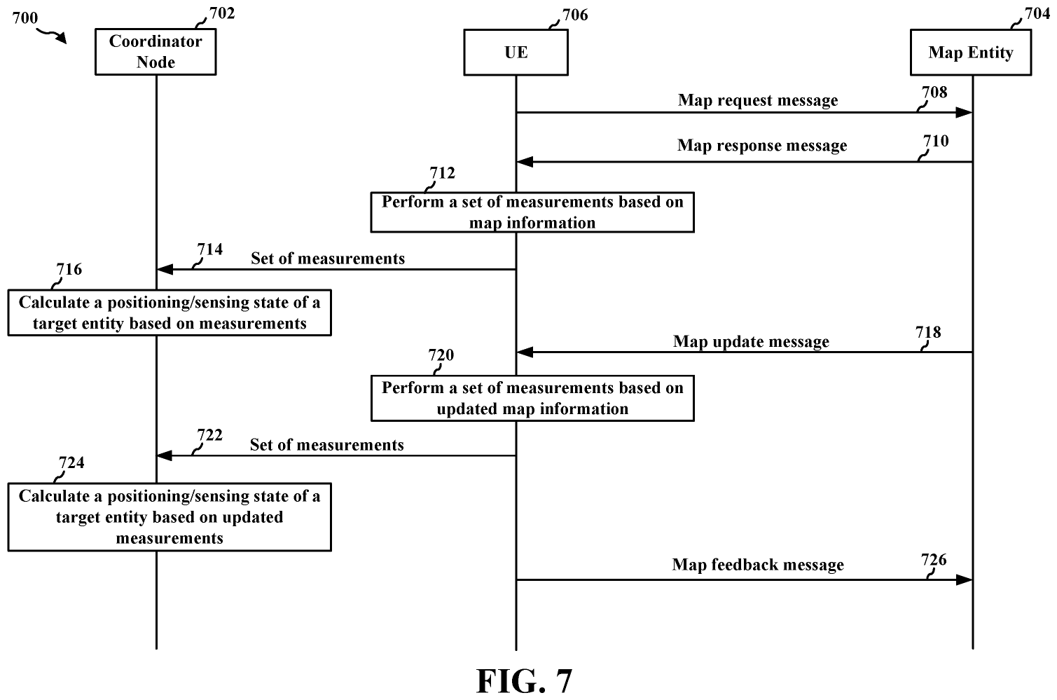

In some aspects, a UE may request map information from the coordinator node or the external map entity. The UE map request may include similar content as described above with reference to the map request provided by the coordinator node. For example, the UE may provide the map request to the coordinator node. If the coordinator node is able to satisfy the map request, the coordinator node may provide the map information to the UE in its map response message. If the coordinator node is not able to satisfy the map request, the coordinator node may request the map from the corresponding network (or external) map entity and provides a map response to the UE accordingly. Additional details regarding such aspects are described below with reference to FIGS. 6A and 6B. In another example, the UE may provide a UE request message to the external map entity without having the coordinator node as an intermediary node relaying or satisfying requests. Additional details regarding such aspects are described below with reference to FIG. 7. As described below, map update messages and map feedback messages may also be utilized with the UE usage of the map information. It is noted that the UE map request may not be fulfilled in the event that the coordinator node or the external map entity does not have map information that satisfies the map request.

In some aspects, a UE may indicate its capability for processing maps, as part of a positioning or sensing capability message to the coordinator node. The indication may include the supported map format (e.g., the map format supported by the UE), the supported map dimensions (e.g., 2D and/or 3D) (e.g., the map dimensions supported by the UE), etc. Based on the indication, the coordinator node may indicate to the UE the availability of maps in its environment that may be used for UE-based positioning. It is noted that the coordinator node may be aware of the location of the UE and may have knowledge of whether certain maps (maintained by the coordinator node and/or the external map entity) cover the area in which the UE is located.

FIG. 6A and FIG. 6B depict a call flow diagram 600 and a call flow diagram 601, respectively, illustrating a method of wireless communication in accordance with various aspects of this present disclosure. As shown in FIGS. 6A and 6B, call flow diagram 600 and call flow diagram 601 include a coordinator node 602, a map entity 604, and a UE 606. Examples of the coordinator node 602 include the LMF 166, the SnMF 167, the coordinator node 502, or a network node, such as the base station 102, or the base station 310. Examples of the map entity 604 include, but are not limited to, the map entity 504 or a GIS-based database. Examples of the UE 606 include, but are not limited to, the UE 104, the UE 350, or the UE 404. Although aspects are described for the network node, the aspects may be performed by a network node in aggregation and/or by one or more components of the network node (e.g., such as a CU 110, a DU 130, and/or an RU 140). As shown in FIG. 6A, at 607, the UE 606 may transmit, to the coordinator node 602, a capability indication that indicates that the UE 606 has a capability to receive and process map information from the coordinator node 602.

At 608, the UE 606 may transmit, to the coordinator node 602, a map request message for map information, for example, for a positioning session and/or an RF sensing session. In some aspects, the map request message may indicate a geographical boundary associated with the requested map information, a constraint specifying a time frame for when the map information was generated, a format of the map information, and/or a dimensionality of the map information.

At 610, the coordinator node 602 may determine whether the coordinator node 602 includes (e.g., stores) the requested map information. If the coordinator node 602 determines that it includes the requested map information, the coordinator node 602 may provide a map response message at 612, which includes the requested map information, to the UE 606. The map response message may include an indication of the format of the map information. The map information may be based on the geographical boundary indicated in the map request message. If the coordinator node 602 determines that it does not include the requested map information, the coordinator node 602 may, at 630, provide a map request message to the map entity 604 for the map information requested by the UE 606. The coordinator node 602 may obtain the requested map information from the map entity 604, for example, prior to receiving the map request message at 608, in a similar manner as described above with reference to FIG. 5.

At 614, the UE 606 may perform a set of measurements for the positioning session and/or RF sensing session based on the map information received at 612.

At 616, the UE 606 may provide the set of measurements to the coordinator node 602.

At 618, the coordinator node 602 may calculate a positioning and/or sensing state of a target entity based on the map information and the set of measurements received at 616. In some aspects, the positioning state may include information indicative of at least one of a location of the target entity, a velocity of the target entity, or a heading of the target entity. In some aspects, the sensing state may include information indicative of at least one of a change of an environment for which the set of sensing measurements were obtained, at least one physiological characteristic of the target entity, a location of the target entity, a velocity of the target entity, or a heading of the target entity.

At 620, the coordinator node 602 may provide a map update message to the UE 606. The map update message may include updated map information for the positioning and/or sensing session.

At 622, the UE 606 may perform a set of measurements for the positioning and/or sensing session based on the updated map information.

At 624, the UE 606 may transmit a map feedback message to the coordinator node 602. The map feedback message may include one of an indication that at least a portion of the map information (either received at 608 or 620) is invalid or incomplete. For example, the UE 606 may execute map validity tests and may determine (e.g., or suspect), based on the validity tests, that parts of the map information are invalid or incomplete. The UE 606 may transmit the map feedback message if the UE 606 determines that the received map information is invalid or incomplete. Otherwise, the UE 606 may not provide the map feedback message.

At 626, the UE 606 may provide the updated set of measurements based on the updated map information to the coordinator node 602.

At 628, the coordinator node 602 may calculate an updated positioning/sensing state of the target entity based on the updated map information.

As described above, at 630, based on a determination by the coordinator node 602 that the coordinator node 602 does not include the map information, the coordinator node 602 may provide a map request message for map information, for example, for a positioning session and/or an RF sensing session, to the map entity 604. The map request message provided at 630 may be based on the map request message received at 608, and thus, includes the same information. In an example, the coordinator node 602 may forward the map request message received at 608 to the map entity 604 at 630.

At 632, the map entity 604 may provide a map response message including the requested map information to the coordinator node 602. The map response message may include an indication of the format of the map information. The map information may be based on the geographical boundary indicated in the map request message.

At 634, the coordinator node 602 may provide a map response message including the map information to the map entity UE 606. The map response message provided at 634 may be based on the map response message received at 632, and thus, includes the same information. In an example, the coordinator node 602 may forward the map response message received at 632 to the UE 606 at 634.

At 636, the UE 606 may perform a set of measurements for the positioning session and/or RF sensing session based on the map information received at 634.

At 638, the UE 606 may provide the set of measurements to the coordinator node 602.

At 640, the coordinator node 602 may calculate a positioning and/or sensing state of a target entity based on the map information and the set of measurements received at 616. In some aspects, the positioning state may include information indicative of at least one of a location of the target entity, a velocity of the target entity, or a heading of the target entity. In some aspects, the sensing state may include information indicative of at least one of a change of an environment for which the set of sensing measurements were obtained, at least one physiological characteristic of the target entity, a location of the target entity, a velocity of the target entity, or a heading of the target entity.

In some aspects, at 642, map entity 604 may provide a map update message to the coordinator node 602. The map update message may include updated map information for the positioning and/or sensing session.

At 644, the coordinator node 602 may provide a map update message including the map information to the UE 606. The map update message provided at 644 may be based on the map update message received at 642, and thus, includes the same information. In an example, the coordinator node 602 may forward the map update message received at 642 to the UE 606 at 644.

At 646, the UE 606 may perform a set of measurements for the positioning session and/or RF sensing session based on the updated map information received at 644.

At 648, the UE 606 may transmit a map feedback message to the coordinator node 602. The map feedback message may include one of an indication that at least a portion of the map information is invalid or incomplete. For example, the UE 606 may execute map validity tests and may determine (e.g., or suspect), based on the validity tests, that parts of the map information are invalid or incomplete. The UE 606 may transmit the map feedback message if the UE 606 determines that the received map information is invalid or incomplete. Otherwise, the UE 606 may not provide the map feedback message.

At 650, the coordinator node 602 may provide a map feedback message including one of the indications that at least a portion of the map information is invalid or incomplete to the map entity 604. The map feedback message provided at 650 may be based on the map feedback message received at 648, and thus, includes the same information. In an example, the coordinator node 602 may forward the map feedback message received at 648 to the map entity 604 at 650.

At 652, the UE 606 may provide the updated set of measurements based on the updated map information to the coordinator node 602.

At 654, the coordinator node 602 may calculate an updated positioning/sensing state of the target entity based on the updated map information.

FIG. 7 depicts a call flow diagram 700 illustrating a method of wireless communication in accordance with various aspects of this present disclosure. As shown in FIG. 7, the diagram 700 includes a coordinator node 702, a map entity 704, and a UE 706. Examples of the coordinator node 702 include the LMF 166, the SnMF 167, the coordinator node 502, the coordinator node 602, or a network node, such as the base station 102 or the base station 310. Examples of the map entity 704 include, but are not limited to, the map entity 504, the map entity 604, or a GIS-based database. Examples of the UE 706 include, but are not limited to, the UE 104, the UE 350, the UE 404, or the UE 606. Although aspects are described for the network node, the aspects may be performed by a network node in aggregation and/or by one or more components of the network node (e.g., such as a CU 110, a DU 130, and/or an RU 140). As shown in FIG. 7, at 708, the UE 706 may transmit, to the map entity 704, a map request message for map information, for example, for a positioning session and/or an RF sensing session. In some aspects, the map request message may indicate a geographical boundary associated with the requested map information, a constraint specifying a time frame for when the map information was generated, a format of the map information, and/or a dimensionality of the map information.

At 710, the map entity 704 may provide a map response message, which includes the requested map information, to the UE 706. The map response message may include an indication of the format of the map information. The map information may be based on the geographical boundary indicated in the map request message.

At 712, the UE 706 may perform a set of measurements for the positioning session and/or RF sensing session based on the map information received at 710.

At 714, the UE 706 may provide the set of measurements to the coordinator node 702.

At 716, the coordinator node 702 may calculate a positioning and/or sensing state of a target entity based on the map information and the set of measurements received at 714. In some aspects, the positioning state may include information indicative of at least one of a location of the target entity, a velocity of the target entity, or a heading of the target entity. In some aspects, the sensing state may include information indicative of at least one of a change of an environment for which the set of sensing measurements were obtained, at least one physiological characteristic of the target entity, a location of the target entity, a velocity of the target entity, or a heading of the target entity.

At 718, map entity 704 may provide a map update message to the UE 706. The map update message may include updated map information for the positioning and/or sensing session.

At 720, the UE 706 may perform a set of measurements for the positioning and/or sensing session based on the updated map information.

At 722. the UE 706 may provide the updated set of measurements based on the updated map information to the coordinator node 702.

At 724, the coordinator node 702 may calculate an updated positioning/sensing state of the target entity based on the updated map information.

At 726, the UE 706 may transmit a map feedback message to map entity 704. The map feedback message may include one of an indication that at least a portion of the map information is invalid or incomplete. For example, the UE 706 may execute map validity tests and may determine (e.g., or suspect), based on the validity tests, that parts of the map information are invalid or incomplete. The UE 706 may transmit the map feedback message if the UE 706 determines that the received map information is invalid or incomplete. Otherwise, the UE 706 may not provide the map feedback message.

In some aspects, UEs may exchange map information through UE-to-UE communication. The information exchange may occur via a first UE sensing (e.g., receiving) a map request message and a second UE sending a map response message (e.g., to the first UE). Otherwise, the second UE may advertise its map information sharing capability in a broadcast message, e.g., as part of a sidelink SSB (S-SSB), or a beacon signal. The second UE may be a dedicated sensing UE (e.g., a roadside unit (RSU) deployed for positioning and potentially sensing purposes). The second UE may also advertise its map capability at the beginning of a positioning session initiated by the first UE. The sharing of the map information may occur using sidelink (SL) communication techniques utilized for cellular technology (e.g., 5G, 6G, etc.), such as SL signaling, Wi-Fi-based technology, such as Wi-Fi-based signaling, or ultra-wideband (UWB)-based technology, such as UWB-based signaling. Map update messages and map feedback messages may also be exchanged between UEs in a similar manner described above with respect to the UE, the coordinator node, and the external map entity.

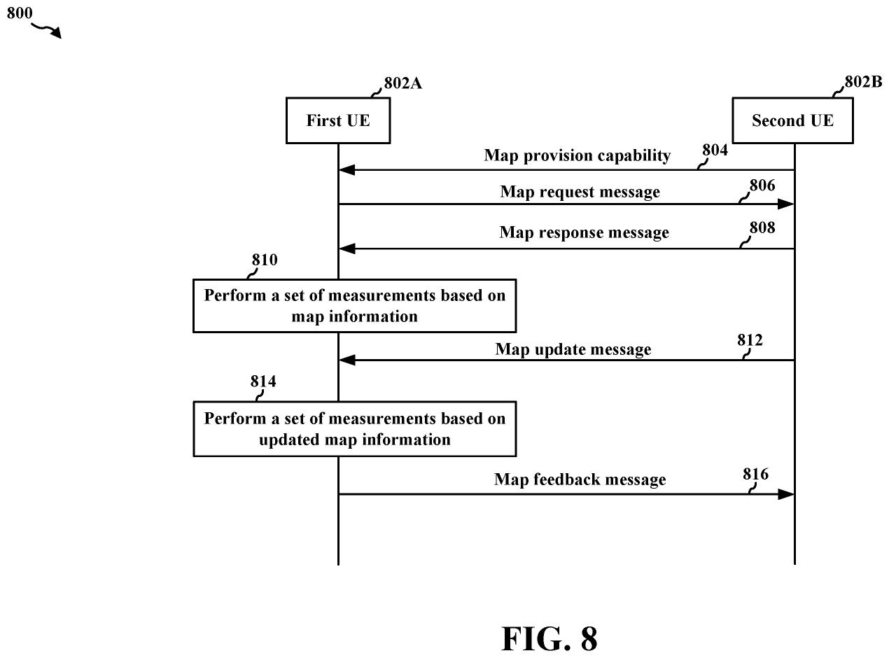

FIG. 8 depicts a call flow diagram 800 illustrating a method of wireless communication in accordance with various aspects of this present disclosure. As shown in FIG. 8, the call flow diagram 800 includes a first UE 802A and a second UE 802B. Examples of the first UE 802A and the second UE 802B include, but are not limited to, the UE 104, the UE 350, the UE 404, the UE 606, or the UE 706. As shown in FIG. 8, at 804, the second UE 802B may transmit, to the first UE 802A, a capability indication that indicates that the second UE 802B has a capability to provide map information.

At 806, the first UE 802A may transmit, to the second UE 802B, a map request message for map information, for example, for a positioning session and/or an RF sensing session. In some aspects, the map request message may indicate a geographical boundary associated with the requested map information, a constraint specifying a time frame for when the map information was generated, a format of the map information, and/or a dimensionality of the map information.

At 808, the second UE 802B may transmit, to the first UE 802A, a map response message, which includes the requested map information. The map response message may include an indication of the format of the map information. The map information may be based on the geographical boundary indicated in the map request message.

At 810, the first UE 802A may perform a set of measurements for the positioning session and/or RF sensing session based on the map information received at 808.

In some aspects, the first UE 802A may calculate a positioning and/or sensing state of a target entity based on the map information and the set of measurements determined at 810. In some aspects, the positioning state may include information indicative of at least one of a location of the target entity, a velocity of the target entity, or a heading of the target entity. In some aspects, the sensing state may include information indicative of at least one of a change of an environment for which the set of sensing measurements were obtained, at least one physiological characteristic of the target entity, a location of the target entity, a velocity of the target entity, or a heading of the target entity. In other aspects, the first UE 802A may provide the set of measurements to another network entity, such as the coordinator node, which calculates the positioning and/or sensing state of the target entity based on the provided set of measurements.

At 812, the second UE 802B may transmit a map update message to the first UE 802A. The map update message may include updated map information for the positioning and/or sensing session.

At 814, the first UE 802A may perform a set of measurements for the positioning session and/or RF sensing session based on the updated map information received at 812.

In some aspects, the first UE 802A may calculate an updated positioning and/or sensing state of a target entity based on the updated map information and the set of measurements determined at 810. In other aspects, the first UE 802A may provide the set of measurements to another network entity, such as the coordinator node, which calculates the updated positioning and/or sensing state of the target entity based on the provided set of updated measurements.

At 816, the first UE 802A may transmit a map feedback message to the second UE 802B. The map feedback message may include one of an indication that at least a portion of the map information is invalid or incomplete. For example, the first UE 802A may execute map validity tests and may determine (e.g., or suspect), based on the validity tests, that parts of the map information are invalid or incomplete. The first UE 802A may transmit the map feedback message if the first UE 802A determines that the received map information is invalid or incomplete. Otherwise, the first UE 802A may not provide the map feedback message.

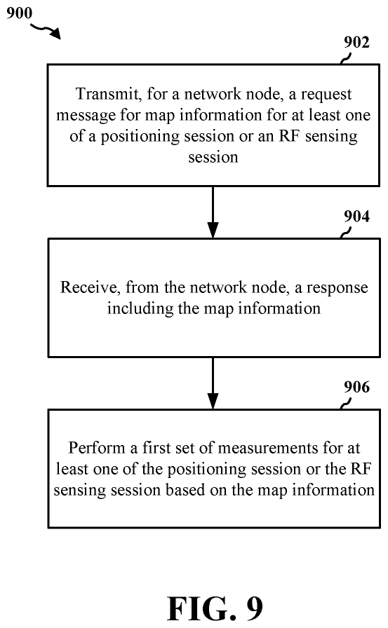

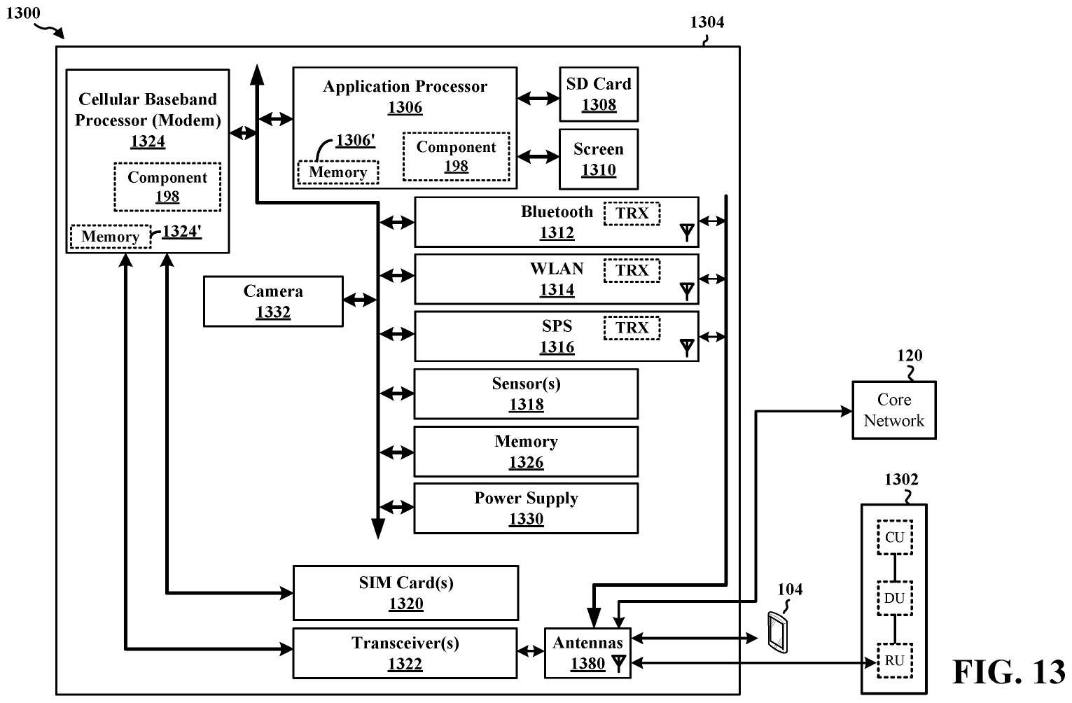

FIG. 9 is a flowchart 900 illustrating methods of wireless communication at a first UE in accordance with various aspects of the present disclosure. In some aspects, the UE may be the UE 104, 350, 404, 606, 706, 802A or 802B, or the apparatus 1304 in the hardware implementation of FIG. 13.

At 902, the first UE may transmit, for a network node, a request message for map information for at least one of a positioning session or an RF sensing session. For example, referring to FIG. 6A, in an aspect in which the network node is a coordinator node, such as the LMF 166, the SnMF 167, or a base station, the UE 606, at 608, may transmit, to the coordinator node 602, a request message for map information for at least one of a positioning session or an RF sensing session. Referring to FIG. 8, in an aspect in which the network node is a second UE, the first UE 802A, at 806, may transmit, to the second UE 802B, a request message for map information for at least one of a positioning session or an RF sensing session. In an aspect, 902 may be performed by the map-aided positioning/sensing component 198.

In some aspects, the network node includes a GIS-based database. For example, referring to FIG. 7, the network node may include the map entity 704, which may be a GIS-based database.

In some aspects, the request message may indicate at least one of a geographical boundary associated with the requested map information, a constraint specifying a time frame for when the map information was generated, a format of the map information, or a dimensionality of the map information. For example, referring to FIG. 6A, the request message transmitted at 608 may indicate at least one of a geographical boundary associated with the requested map information, a constraint specifying a time frame for when the map information was generated, a format of the map information, or a dimensionality of the map information. Referring to FIG. 8, the request message transmitted at 806 may indicate at least one of a geographical boundary associated with the requested map information, a constraint specifying a time frame for when the map information was generated, a format of the map information, or a dimensionality of the map information.

In some aspects, the first UE may transmit a capability indication that indicates the first UE has a capability to receive and process the map information from the network node. For example, referring to FIG. 6A, the UE 606, at 607, may transmit a capability indication that indicates the UE 606 has a capability to receive and process the map information from the coordinator node 602.

At 904, the first UE may receive, from the network node, a response including the map information. For example, referring to FIG. 6A, in an aspect in which the network node is the coordinator node, the UE 606, at 612, may receive a response including the map information. Referring to FIG. 8, in an aspect in which the network node is the second UE, the first UE 802A, at 808, may receive a response including the map information. In an aspect, 904 may be performed by the map-aided positioning/sensing component 198.

In some aspects, the response may include an indication of the format of the map information. The map information may be based on the geographical boundary indicated in the map request message. For example, referring to FIG. 6A, the response received at 612, may include an indication of the format of the map information. The map information may be based on the geographical boundary indicated in the map request message transmitted at 608. Referring to FIG. 8, in an aspect in which the network node is the second UE, the response received at 808 may include an indication of the format of the map information. The map information may be based on the geographical boundary indicated in the map request message transmitted at 708.

In an aspect in which the network node is the second UE, the response may be received from the second UE via at least one of SL signaling, Wi-Fi-based signaling, or UWB-based signaling. For example, referring to FIG. 8, the response received at 808 may be received from the second UE 802B via at least one of SL signaling, Wi-Fi-based signaling, or UWB-based signaling.

At 906, the first UE may perform a first set of measurements for at least one of the positioning session or the RF sensing session based on the map information. For example, referring to FIG. 6A, in an aspect in which the network node is the coordinator node, the UE 606, at 614, may perform a first set of measurements for at least one of the positioning session or the RF sensing session based on the map information received at 612. Referring to FIG. 8 in an aspect in which the network node is the second UE, the first UE 802A, at 810, may perform a first set of measurements for at least one of the positioning session or the RF sensing session based on the map information received at 808. In an aspect, 906 may be performed by the map-aided positioning/sensing component 198.

In some aspects, the first UE may transmit, for the network node, a feedback message including one of an indication that at least a portion of the map information is invalid or incomplete. For example, referring to FIG. 6A, in an aspect in which the network node is the coordinator node, the UE 606, at 624, may provide a map feedback message to the coordinator node 602. Referring to FIG. 8, in an aspect in which the network node is the second UE, the first UE 802A, at 816, may provide a map feedback message to the second UE 802B.

In some aspects, the first UE may receive, from the network node, an update message including updated map information for at least one of the positioning session or the RF sensing session, and perform a second set of measurements for at least one of the positioning session or the RF sensing session based on the updated map information. For example, referring to FIG. 6A, in an aspect in which the network node is the coordinator node, the UE 606, at 620, may receive, from the coordinator node 602, a map update message including updated map information for at least one of the positioning session or the RF sensing session. At 622, the UE 606 may perform a second set of measurements for at least one of the positioning session or the RF sensing session based on the updated map information received at 620. Referring to FIG. 8, in an aspect in which the network node is the second UE, the first UE 802A, at 812, may receive, from the second UE 802B, a map update message including updated map information for at least one of the positioning session or the RF sensing session. At 814, the first UE 802A may perform a second set of measurements for at least one of the positioning session or the RF sensing session based on the updated map information received at 812.

In an aspect in which the network node is the second UE, the first UE may receive, from the second UE, a capability indication that indicates the second UE has a capability to provide the map information. For example, referring to FIG. 8, the first UE 802A may receive, from the second UE 802B, a capability indication that indicates the second UE has a capability to provide the map information.

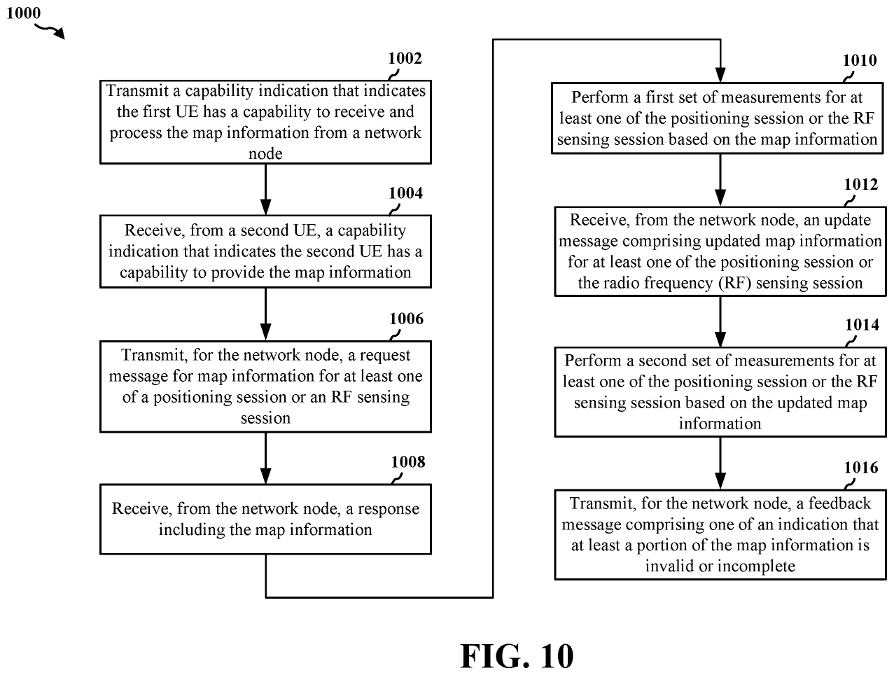

FIG. 10 is a flowchart 1000 illustrating methods of wireless communication at a first UE in accordance with various aspects of the present disclosure. In some aspects, the UE may be the UE 104, 350, 404, 606, 706, 802A or 802B, or the apparatus 1304 in the hardware implementation of FIG. 13.

At 1002, the first UE may transmit a capability indication that indicates the first UE has a capability to receive and process the map information from a network node. In some aspects, the network node includes one of the LMF 166, the SnMF 167, a second UE, or a base station. For example, referring to FIG. 6A, the UE 606, at 607, may transmit a capability indication that indicates the UE 606 has a capability to receive and process the map information from the coordinator node 602. In an aspect, 1002 may be performed by the map-aided positioning/sensing component 198.

At 1004, in an aspect in which the network node is the second UE, the first UE may receive, from the second UE, a capability indication that indicates the second UE has a capability to provide the map information. For example, referring to FIG. 8, the first UE 802A may receive, from the second UE 802B, a capability indication that indicates the second UE has a capability to provide the map information. In an aspect, 1004 may be performed by the map-aided positioning/sensing component 198.

At 1006, the first UE may transmit, for the network node, a request message for map information for at least one of a positioning session or an RF sensing session. For example, referring to FIG. 6A, in an aspect in which the network node is a coordinator node, such as the LMF 166, the SnMF 167, or a base station, the UE 606, at 608, may transmit, to the coordinator node 602, a request message for map information for at least one of a positioning session or an RF sensing session. Referring to FIG. 8, in an aspect in which the network node is a second UE, the first UE 802A, at 806, may transmit, to the second UE 802B, a request message for map information for at least one of a positioning session or an RF sensing session. In an aspect, 1006 may be performed by the map-aided positioning/sensing component 198.

In some aspects, the network node includes a GIS-based database. For example, referring to FIG. 7, the network node may include the map entity 704, which may be a GIS-based database.

In some aspects, the request message may indicate at least one of a geographical boundary associated with the requested map information, a constraint specifying a time frame for when the map information was generated, a format of the map information, or a dimensionality of the map information. For example, referring to FIG. 6A, the request message transmitted at 608 may indicate at least one of a geographical boundary associated with the requested map information, a constraint specifying a time frame for when the map information was generated, a format of the map information, or a dimensionality of the map information. Referring to FIG. 8, the request message transmitted at 806 may indicate at least one of a geographical boundary associated with the requested map information, a constraint specifying a time frame for when the map information was generated, a format of the map information, or a dimensionality of the map information.

At 1008, the first UE may receive, from the network node, a response including the map information. For example, referring to FIG. 6A, in an aspect in which the network node is the coordinator node, the UE 606, at 612, may receive a response including the map information. Referring to FIG. 8, in an aspect in which the network node is the second UE, the first UE 802A, at 808, may receive a response including the map information. In an aspect, 1008 may be performed by the map-aided positioning/sensing component 198.

In some aspects, the response may include an indication of the format of the map information. The map information may be based on the geographical boundary indicated in the map request message. For example, referring to FIG. 6A, the response received at 612, may include an indication of the format of the map information. The map information may be based on the geographical boundary indicated in the map request message transmitted at 608. Referring to FIG. 8, in an aspect in which the network node is the second UE, the response received at 808 may include an indication of the format of the map information. The map information may be based on the geographical boundary indicated in the map request message transmitted at 708.

In an aspect in which the network node is the second UE, the response may be received from the second UE via at least one of SL signaling, Wi-Fi-based signaling, or UWB-based signaling. For example, referring to FIG. 8, the response received at 808 may be received from the second UE 802B via at least one of SL signaling, Wi-Fi-based signaling, or UWB-based signaling.

At 1010, the first UE may perform a first set of measurements for at least one of the positioning session or the RF sensing session based on the map information. For example, referring to FIG. 6A, in an aspect in which the network node is the coordinator node, the UE 606, at 614, may perform a first set of measurements for at least one of the positioning session or the RF sensing session based on the map information received at 612. Referring to FIG. 8 in an aspect in which the network node is the second UE, the first UE 802A, at 810, may perform a first set of measurements for at least one of the positioning session or the RF sensing session based on the map information received at 808. In an aspect, 1010 may be performed by the map-aided positioning/sensing component 198.

At 1012, the first UE may receive, from the network node, an update message including updated map information for at least one of the positioning session or the RF sensing session. For example, referring to FIG. 6A, in an aspect in which the network node is the coordinator node, the UE 606, at 620, may receive, from the coordinator node 602, a map update message including updated map information for at least one of the positioning session or the RF sensing session. Referring to FIG. 8, in an aspect in which the network node is the second UE, the first UE 802A, at 812, may receive, from the second UE 802B, a map update message including updated map information for at least one of the positioning session or the RF sensing session. In an aspect, 1012 may be performed by the map-aided positioning/sensing component 198.

At 1014, the first UE may perform a second set of measurements for at least one of the positioning session or the RF sensing session based on the updated map information. For example, in an aspect in which the network node is the coordinator node, the UE 606, at 622, may perform a second set of measurements for at least one of the positioning session or the RF sensing session based on the updated map information received at 620. Referring to FIG. 8, in an aspect in which the network node is the second UE, the first UE 802A, the first UE 802A, at 814 may perform a second set of measurements for at least one of the positioning session or the RF sensing session based on the updated map information received at 812. In an aspect, 1014 may be performed by the map-aided positioning/sensing component 198.

At 1016, the first UE may transmit, for the network node, a feedback message including one of an indication that at least a portion of the map information is invalid or incomplete. For example, referring to FIG. 6A, in an aspect in which the network node is the coordinator node, the UE 606, at 624, may provide a map feedback message to the coordinator node 602. Referring to FIG. 8, in an aspect in which the network node is the second UE, the first UE 802A, at 816, may provide a map feedback message to the second UE 802B. In an aspect, 1016 may be performed by the map-aided positioning/sensing component 198.

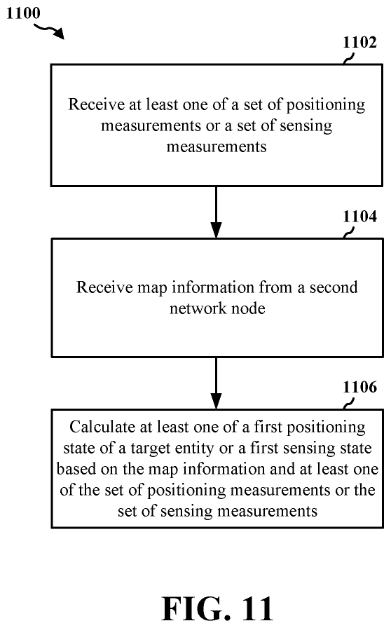

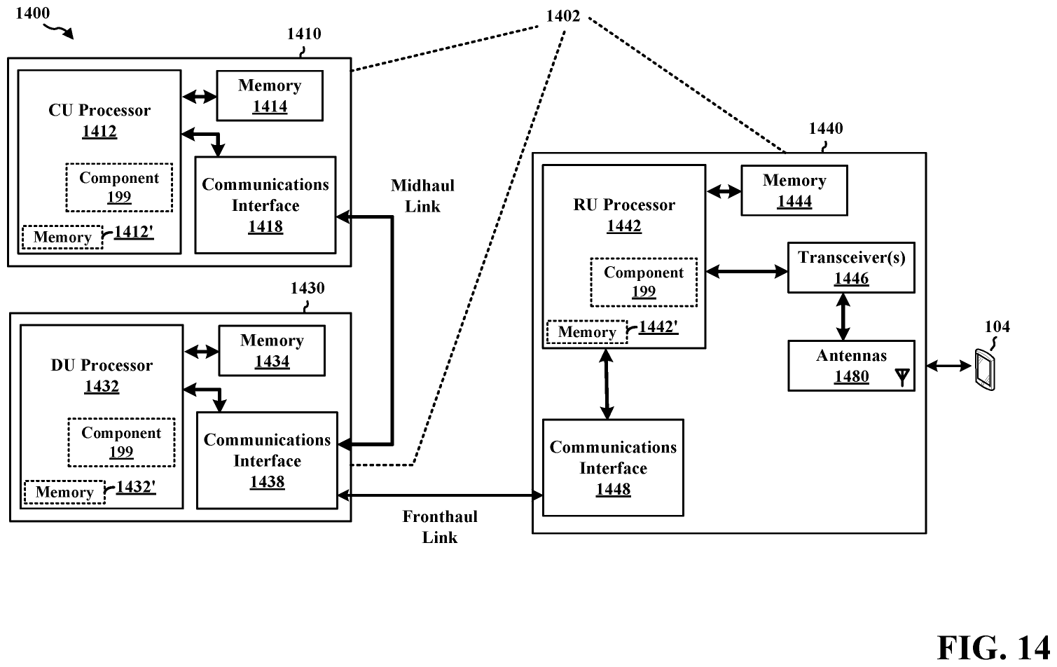

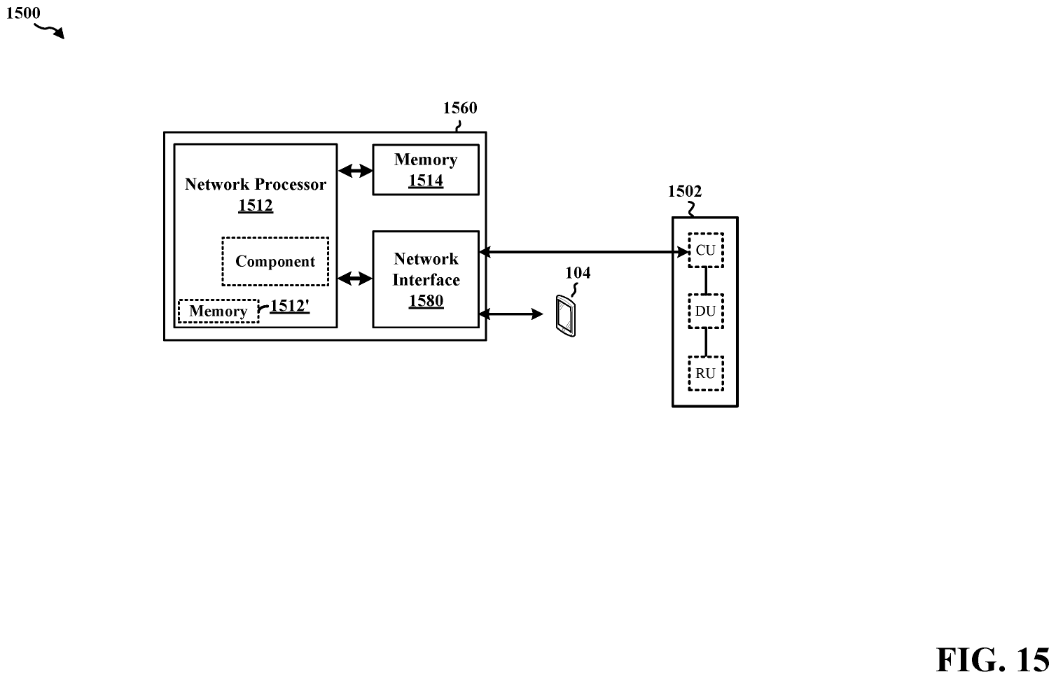

FIG. 11 is a flowchart 1100 illustrating methods of wireless communication at a first network node in accordance with various aspects of the present disclosure. In some aspects, the first network node may be the LMF 166, the SnMF 167, the base station 102, the base station 310, the coordinator node 502, the coordinator node 602, or the coordinator node 702, the network entity 1402 in the hardware implementation of FIG. 14, or the network entity 1560 in the hardware implementation of FIG. 15.

At 1102, the first network node may receive at least one of a set of positioning measurements or a set of sensing measurements. For example, referring to FIG. 6B, the coordinator node 602, at 638, may receive at least one of a set of positioning measurements or a set of sensing measurements from the UE 606. In an aspect, 1102 may be performed by the map-aided positioning/sensing component 199.

At 1104, the first network node may receive map information from a second network node. For example, referring to FIG. 6B, the coordinator node 602, at 632, may receive a response including the requested map information from the map entity 604. In an aspect, 1104 may be performed by the map-aided positioning/sensing component 199.

In some aspects, the second network node may include a GIS-based database. For example, referring to FIG. 6B, the map entity 604 may include a GIS-based database.

In some aspects, the first network node may receive the map information from the second node by determining that the first network node does not include the map information, transmitting, for the second network node based on the determination that the first network node does not include the map information, a request message for the map information, and receiving, from the second network node, a response including the map information. For example, referring to FIGS. 6A and 6B, the coordinator node 602, at 610, may determine that the coordinator node 602 does not include the map information. At 630, the coordinator node 602 may transmit, to the map entity 604 based on the determination at 610 that the coordinator node 602 does not include the map information, a request message for the map information. At 632, the coordinator node 602 may receive, from the map entity 604, a response including the map information.

At 1106, the first network node may calculate at least one of a first positioning state of a target entity or a first sensing state based on the map information and at least one of the set of positioning measurements or the set of sensing measurements. For example, referring to FIG. 6B, the coordinator node 602, at 640, may calculate at least one of a first positioning state of a target entity or a first sensing state based on the map information received at 632 and at least one of the set of positioning measurements or the set of sensing measurements received at 638. In an aspect, 1106 may be performed by the map-aided positioning/sensing component 199.

In some aspects, the first positioning state may include information indicative of at least one of a location of the target entity, a velocity of the target entity, or a heading of the target entity. For example, referring to FIG. 6A, the first positioning state calculated at 640 may include information indicative of at least one of a location of the target entity, a velocity of the target entity, or a heading of the target entity.

In some aspects, the first sensing state may include information indicative of at least one of a change of an environment for which the set of sensing measurements were obtained, at least one physiological characteristic of the target entity, a location of the target entity, a velocity of the target entity, or a heading of the target entity. For example, referring to FIG. 6A, the first sensing state calculated at 640 may include information indicative of at least one of a change of an environment for which the set of sensing measurements were obtained, at least one physiological characteristic of the target entity, a location of the target entity, a velocity of the target entity, or a heading of the target entity.

In some aspects, prior to the calculation of at least one of the first positioning state or the first sensing state, the first network node may receive the at least one of the set of positioning measurements or the set of sensing measurements from at least one of a UE or a TRP. For example, referring to FIG. 6A, prior to the calculation of at least one of the first positioning state or the first sensing state at 618, the coordinator node 602, at 616, receive the at least one of the set of positioning measurements or the set of sensing measurements from at least one of the UE 606 or a TRP (e.g., the TRP 402 or TRP 406).

In some aspects, the first network node may receive, from the second network node, an update message including updated map information, and may calculate at least one of a second positioning state of the target entity or a second sensing state based on the updated map information and at least one of the set of positioning measurements or the set of sensing measurements. For example, referring to FIG. 6B, the coordinator node 602, at 642, may receive, from the map entity 604, an update message including updated map information. The coordinator node 602, at 654, may calculate at least one of a second positioning state of the target entity or a second sensing state based on the updated map information received at 642 and at least one of the set of positioning measurements or the set of sensing measurements received at 638 and/or 652. In some aspects, the coordinator node 602 may forward the update message received at 642 to the UE 606 at 644.

In some aspects, the first network node may transmit, for the second network node, a feedback message including one of an indication that at least a portion of the map information is invalid or incomplete. For example, referring to FIG. 6B, the coordinator node 602 may transmit, to the map entity 604, a feedback message including one of an indication that at least a portion of the map information is invalid or incomplete. In some aspects, the feedback message may be provided to the coordinator node 602 from the UE 606 at 648, and the coordinator node 602 may forward the feedback message to the map entity at 650.

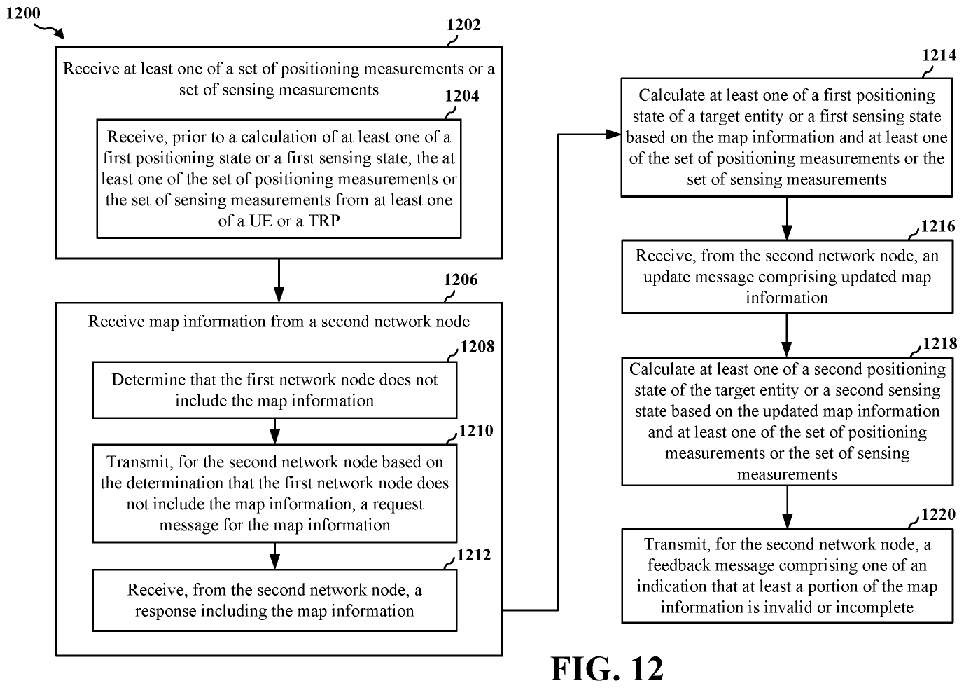

FIG. 12 is a flowchart 1200 illustrating methods of wireless communication at a first network node in accordance with various aspects of the present disclosure. In some aspects, the first network node may be the LMF 166, the SnMF 167, the base station 102, the base station 310, the coordinator node 502, the coordinator node 602, or the coordinator node 702, the network entity 1402 in the hardware implementation of FIG. 14, or the network entity 1560 in the hardware implementation of FIG. 15.

At 1202, the first network node may receive at least one of a set of positioning measurements or a set of sensing measurements. For example, referring to FIG. 6B, the coordinator node 602, at 638, may receive at least one of a set of positioning measurements or a set of sensing measurements from the UE 606. In an aspect, 1202 may be performed by the map-aided positioning/sensing component 199.

In some aspects, as part of 1202, at 1204, prior to a calculation of at least one of a first positioning state or a first sensing state, the first network node may receive the at least one of the set of positioning measurements or the set of sensing measurements from at least one of a UE or a TRP. For example, referring to FIG. 6A, prior to a calculation of at least one of a first positioning state or a first sensing state at 618, the coordinator node 602, at 616, receive the at least one of the set of positioning measurements or the set of sensing measurements from at least one of the UE 606 or a TRP (e.g., the TRP 402 or TRP 406). In an aspect, 1204 may be performed by the map-aided positioning/sensing component 199.

At 1206, the first network node may receive map information from a second network node. For example, referring to FIG. 6B, the coordinator node 602, at 632, may receive a response including the requested map information from the map entity 604. In an aspect, 1206 may be performed by the map-aided positioning/sensing component 199.

In some aspects, the second network node may include a GIS-based database. For example, referring to FIG. 6B, the map entity 604 may include a GIS-based database.

In some aspects, as part of 1206, at 1208, the first network node may determine that the first network node does not include the map information. For example, referring to FIG. 6A, the coordinator node 602, at 610, may determine that the coordinator node 602 does not include the map information. In an aspect, 1208 may be performed by the map-aided positioning/sensing component 199.

In some aspects, as part of 1206, at 1210, the first network node may transmit, for the second network node based on the determination that the first network node does not include the map information, a request message for the map information. For example, referring to FIG. 6B, at 630, the coordinator node 602 may transmit, to the map entity 604 based on the determination at 610 that the coordinator node 602 does not include the map information, a request message for the map information. In an aspect, 1210 may be performed by the map-aided positioning/sensing component 199.

In some aspects, as part of 1206, at 1212, the network node may receive, from the second network node, a response including the map information. For example, referring to FIG. 6B, at 632, the coordinator node 602 may receive, from the map entity 604, a response including the map information. In an aspect, 1212 may be performed by the map-aided positioning/sensing component 199.

At 1214, the first network node may calculate at least one of a first positioning state of a target entity or a first sensing state based on the map information and at least one of the set of positioning measurements or the set of sensing measurements. For example, referring to FIG. 6B, the coordinator node 602, at 640, may calculate at least one of a first positioning state of a target entity or a first sensing state based on the map information received at 632 and at least one of the set of positioning measurements or the set of sensing measurements received at 638. In an aspect, 1214 may be performed by the map-aided positioning/sensing component 199.

In some aspects, the first positioning state may include information indicative of at least one of a location of the target entity, a velocity of the target entity, or a heading of the target entity. For example, referring to FIG. 6A, the first positioning state calculated at 640 may include information indicative of at least one of a location of the target entity, a velocity of the target entity, or a heading of the target entity.

In some aspects, the first sensing state may include information indicative of at least one of a change of an environment for which the set of sensing measurements were obtained, at least one physiological characteristic of the target entity, a location of the target entity, a velocity of the target entity, or a heading of the target entity. For example, referring to FIG. 6A, the first sensing state calculated at 640 may include information indicative of at least one of a change of an environment for which the set of sensing measurements were obtained, at least one physiological characteristic of the target entity, a location of the target entity, a velocity of the target entity, or a heading of the target entity.

At 1216, the first network node may receive, from the second network node, an update message including updated map information, and. For example, referring to FIG. 6B, the coordinator node 602, at 642, may receive, from the map entity 604, an update message including updated map information. In some aspects, the coordinator node 602 may forward the update message received at 642 to the UE 606 at 644. In an aspect, 1216 may be performed by the map-aided positioning/sensing component 199.

At 1218, the first network node may calculate at least one of a second positioning state of the target entity or a second sensing state based on the updated map information and at least one of the set of positioning measurements or the set of sensing measurements. For example, referring to FIG. 6B, the coordinator node 602, at 654, may calculate at least one of a second positioning state of the target entity or a second sensing state based on the updated map information received at 642 and at least one of the set of positioning measurements or the set of sensing measurements received at 638 and/or 652. In an aspect, 1218 may be performed by the map-aided positioning/sensing component 199.

At 1220, the first network node may transmit, for the second network node, a feedback message including one of an indication that at least a portion of the map information is invalid or incomplete. For example, referring to FIG. 6B, the coordinator node 602 may transmit, to the map entity 604, a feedback message including one of an indication that at least a portion of the map information is invalid or incomplete. In some aspects, the feedback message may be provided to the coordinator node 602 from the UE 606 at 648, and the coordinator node 602 may forward the feedback message to the map entity at 650. In an aspect, 1220 may be performed by the map-aided positioning/sensing component 199.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104, the core network 120, and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed supra, the component 198 may be configured to transmit, for a network node, a request message for map information for at least one of a positioning session or an RF sensing session, to receive, from the network node, a response including the map information, and to perform a first set of measurements for at least one of the positioning session or the RF sensing session based on the map information. The component 198 may be configured to perform any of the aspects described in connection with the flowcharts in FIGS. 9 and 10 and/or the aspects performed by the UE 606, the UE 706, the first UE 802A, or the second UE 802B in the communication flows in FIGS. 6A, 6B, 7, and 8. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for transmitting, for a network node, a request message for map information for at least one of a positioning session or an RF sensing session, means for receiving, from the network node, a response including the map information, and means for performing a first set of measurements for at least one of the positioning session or the RF sensing session based on the map information. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′ In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive at least one of a set of positioning measurements or a set of sensing measurements, to receive map information from a second network node, and to calculate at least one of a first positioning state of a target entity or a first sensing state based on the map information and at least one of the set of positioning measurements or the set of sensing measurements. The component 199 may be configured to perform any of the aspects described in connection with the flowcharts in FIGS. 11 and 12 and/or the aspects performed by the coordinator node 502, the coordinator node 602, or the coordinator node 702 in the communication flows in FIGS. 5, 6A-6B, and 7. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for receiving at least one of a set of positioning measurements or a set of sensing measurements, means for receiving map information from a second network node, and means for calculating at least one of a first positioning state of a target entity or a first sensing state based on the map information and at least one of the set of positioning measurements or the set of sensing measurements. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502 and the UE 104. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive at least one of a set of positioning measurements or a set of sensing measurements, to receive map information from a second network node, and to calculate at least one of a first positioning state of a target entity or a first sensing state based on the map information and at least one of the set of positioning measurements or the set of sensing measurements. The component 199 may be configured to perform any of the aspects described in connection with the flowcharts in FIGS. 11 and 12 and/or the aspects performed by the coordinator node 502, the coordinator node 602, or the coordinator node 702 in the communication flows in FIGS. 5, 6A-6B, and 7. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 may include means for receiving at least one of a set of positioning measurements or a set of sensing measurements, means for receiving map information from a second network node, and means for calculating at least one of a first positioning state of a target entity or a first sensing state based on the map information and at least one of the set of positioning measurements or the set of sensing measurements. The means may be the component 199 of the network entity 1560 configured to perform the functions recited by the means.

Various aspects relate generally to positioning systems. Some aspects more specifically relate to positioning or RF sensing utilizing map information. In some examples, a UE may request and receive map information regarding an environment in which a target entity for which a positioning or RF sensing session is to be performed. The UE may request and receive the map information from a coordinator node (e.g., a the LMF, the SnMF, or a base station), an external network entity (e.g., a GIS-based database), or another UE that includes the map information. Based on the map information, the UE may perform a set of measurements for the positioning or RF sensing session. The UE may provide the set of measurements to the coordinator node, which may calculate a positioning or RF sensing state of the target entity. Alternatively, the UE may calculate the positioning or RF sensing state of the target entity based on the set of measurements.

Particular aspects of the subject matter described in this disclosure can be implemented to realize one or more of the following potential advantages. By utilizing map information associated with the particular environment in which the target entity is located, obstacles in the environment in which the target entity is included may be considered, and therefore, the positioning or sensing state (e.g., the direction, heading, or velocity) of the target entity may be more accurately determined.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE, including: transmitting, for a network node, a request message for map information for at least one of a positioning session or an RF sensing session; receiving, from the network node, a response including the map information; and performing a first set of measurements for at least one of the positioning session or the RF sensing session based on the map information.

Aspect 2 is the method of aspect 1, further including: transmitting, for the network node, a feedback message including one of an indication that at least a portion of the map information is invalid or incomplete.

Aspect 3 is the method of any of aspects 1 and 2, further including: receiving, from the network node, an update message including updated map information for at least one of the positioning session or the radio frequency (RF) sensing session; and performing a second set of measurements for at least one of the positioning session or the RF sensing session based on the updated map information.

Aspect 4 is the method of any of aspects 1 to 3, where the network node includes one of an LMF, an SnMF, a second UE, or a base station.

Aspect 5 is the method of aspect 4, where the network node includes the second UE, the method further including: receiving, from the second UE, a capability indication that indicates the second UE has a capability to provide the map information.

Aspect 6 is the method of aspect 5, where the response is received from the second UE via at least one of: SL signaling; Wi-Fi-based signaling; or UWB-based signaling.

Aspect 7 is the method of any of aspects 1 to 6, where the network node includes a GIS-based database.

Aspect 8 is the method of any of aspects 1 to 7, where the request message indicates at least one of: a geographical boundary associated with the map information; a constraint specifying a time frame for when the map information was generated; a format of the map information; or a dimensionality of the map information.

Aspect 9 is the method of aspect 8, where the response includes an indication of the format of the map information, and where the map information is based on the geographical boundary indicated in the request message.

Aspect 10 is the method of any of aspects 1 to 9, further including: transmitting a capability indication that indicates the first UE has a capability to receive and process the map information from the network node.

Aspect 11 is a method of wireless communication at a first network node, including: receiving at least one of a set of positioning measurements or a set of sensing measurements; receiving map information from a second network node; and calculating at least one of a first positioning state of a target entity or a first sensing state based on the map information and at least one of the set of positioning measurements or the set of sensing measurements.

Aspect 12 is the method of aspect 11, where receiving at least one of the set of positioning measurements or the set of sensing measurements includes: receiving, prior to the calculation of at least one of the first positioning state or the first sensing state, the at least one of the set of positioning measurements or the set of sensing measurements from at least one of a UE or TRP.

Aspect 13 is the method of any of aspects 11 and 12, where the first positioning state includes information indicative of at least one of: a location of the target entity; a velocity of the target entity; or a heading of the target entity.

Aspect 14 is the method of any of aspects 11 to 13, where the first sensing state includes information indicative of at least one of: a change of an environment for which the set of sensing measurements were obtained; at least one physiological characteristic of the target entity; a location of the target entity; a velocity of the target entity; or a heading of the target entity.

Aspect 15 is the method of any of aspects 11 to 14, where the first network node includes one of an LMF or an SnMF.

Aspect 16 is the method of any of aspects 11 to 15, where the second network node includes a GIS-based database.

Aspect 17 is the method of any of aspects 11 to 16, where receiving the map information from the second network node includes: determining that the first network node does not include the map information; transmitting, for the second network node based on the determination that the first network node does not include the map information, a request message for the map information; and receiving, from the second network node, a response including the map information.

Aspect 18 is the method of any of aspects 11 to 17, further including: receiving, from the second network node, an update message including updated map information; and calculating at least one of a second positioning state of the target entity or a second sensing state based on the updated map information and at least one of the set of positioning measurements or the set of sensing measurements.

Aspect 19 is the method of any of aspects 11 to 18, further including: transmitting, for the second network node, a feedback message including one of an indication that at least a portion of the map information is invalid or incomplete.

Aspect 20 is an apparatus for wireless communication at a first UE. The apparatus includes memory; and at least one processor coupled to the memory and, based at least in part on information stored in the memory, the at least one processor is configured to implement any of aspects 1 to 10.

Aspect 21 is the apparatus of aspect 20, further including at least one of a transceiver or an antenna coupled to the at least one processor.

Aspect 22 is an apparatus for wireless communication at a first network node. The apparatus includes memory; and at least one processor coupled to the memory and, based at least in part on information stored in the memory, the at least one processor is configured to implement any of aspects 11 to 19.

Aspect 23 is the apparatus of aspect 22, further including at least one of a transceiver or an antenna coupled to the at least one processor.

Aspect 24 is an apparatus for wireless communication including means for implementing any of aspects 1 to 10.

Aspect 25 is an apparatus for wireless communication including means for implementing any of aspects 11 to 19.

Aspect 26 is a computer-readable medium (e.g., a non-transitory computer-readable medium) storing computer executable code, where the code when executed by a processor causes the processor to implement any of aspects 1 to 10.

Aspect 27 is a computer-readable medium (e.g., a non-transitory computer-readable medium) storing computer executable code, where the code when executed by a processor causes the processor to implement any of aspects 11 to 19.

What is claimed is:

1. An apparatus for wireless communication at a first user equipment (UE), comprising:
a memory; and
at least one processor coupled to the memory and, based at least in part on information stored in the memory, the at least one processor is configured to:
transmit, for a network node, a request message for map information for at least one of a positioning session or a radio frequency (RF) sensing session;
receive, from the network node, a response including the map information; and
perform a first set of measurements for at least one of the positioning session or the RF sensing session based on the map information.

2. The apparatus of claim 1, wherein the at least one processor is further configured to:
transmit, for the network node, a feedback message comprising one of an indication that at least a portion of the map information is invalid or incomplete.

3. The apparatus of claim 1, wherein the at least one processor is further configured to:
receive, from the network node, an update message comprising updated map information for at least one of the positioning session or the radio frequency (RF) sensing session; and
perform a second set of measurements for at least one of the positioning session or the RF sensing session based on the updated map information.

4. The apparatus of claim 1, wherein the network node comprises one of a location management function (LMF), a sensing management function (SnMF), a second UE, or a base station.

5. The apparatus of claim 4, wherein the network node comprises the second UE, and wherein the at least one processor is further configured to:
receive, from the second UE, a capability indication that indicates the second UE has a capability to provide the map information.

6. The apparatus of claim 5, wherein to receive the response, the at least one processor is configured to receive the response from the second UE via at least one of:
sidelink (SL) signaling;
Wi-Fi-based signaling; or
ultra-wideband (UWB)-based signaling.

7. The apparatus of claim 1, wherein the network node comprises a geographic information system (GIS)-based database.

8. The apparatus of claim 1, wherein the request message indicates at least one of:
a geographical boundary associated with the map information;
a constraint specifying a time frame for when the map information was generated;
a format of the map information; or
a dimensionality of the map information.

9. The apparatus of claim 8, wherein the response comprises an indication of the format of the map information, and wherein the map information is based on the geographical boundary indicated in the request message.

10. The apparatus of claim 1, further comprising at least one of a transceiver or an antenna coupled to the at least one processor, wherein the at least one processor is further configured to:
transmit, via at least one of the transceiver or the antenna, a capability indication that indicates the first UE has a capability to receive and process the map information from the network node.

11. An apparatus of wireless communication at a first network node, comprising:
a memory; and
at least one processor coupled to the memory and, based at least in part on information stored in the memory, the at least one processor is configured to:
receive at least one of a set of positioning measurements or a set of sensing measurements;
receive map information from a second network node; and
calculate at least one of a first positioning state of a target entity or a first sensing state based on the map information and at least one of the set of positioning measurements or the set of sensing measurements.

12. The apparatus of claim 11, wherein, to receive at least one of the set of positioning measurements or the set of sensing measurements, the at least one processor is configured to:
receive, prior to the calculation of at least one of the first positioning state or the first sensing state, the at least one of the set of positioning measurements or the set of sensing measurements from at least one of a user equipment (UE) or a transmission reception point (TRP).

13. The apparatus of claim 11, wherein the first positioning state comprises first information indicative of at least one of:
a location of the target entity;
a velocity of the target entity; or
a heading of the target entity.

14. The apparatus of claim 11, wherein the first sensing state comprises first information indicative of at least one of:
a change of an environment for which the set of sensing measurements were obtained;
at least one physiological characteristic of the target entity;
a location of the target entity;
a velocity of the target entity; or
a heading of the target entity.

15. The apparatus of claim 11, wherein the first network node comprises one of a location management function (LMF) or a sensing management function (SnMF).

16. The apparatus of claim 11, wherein the second network node comprises a geographic information system (GIS)-based database.

17. The apparatus of claim 11, wherein, to receive the map information from the second network node, the at least one processor is configured to:
determine that the first network node does not include the map information;
transmit, for the second network node based on the determination that the first network node does not include the map information, a request message for the map information; and
receive, from the second network node, a response including the map information.

18. The apparatus of claim 11, wherein the at least one processor is further configured to:
receive, from the second network node, an update message comprising updated map information; and
calculate at least one of a second positioning state of the target entity or a second sensing state based on the updated map information and at least one of the set of positioning measurements or the set of sensing measurements.

19. The apparatus of claim 11, further comprising at least one of a transceiver or an antenna coupled to the at least one processor, wherein the at least one processor is further configured to:
transmit, for the second network node via at least one of the transceiver or the antenna, a feedback message comprising one of an indication that at least a portion of the map information is invalid or incomplete.

20. A method of wireless communication at a first user equipment (UE), comprising:
transmitting, for a network node, a request message for map information for at least one of a positioning session or a radio frequency (RF) sensing session;
receiving, from the network node, a response including the map information; and
performing a first set of measurements for at least one of the positioning session or the RF sensing session based on the map information.
